(19) United States
(12) Patent Application Publication
(10) Pub. No.: US 2008/0198450 A1
(43) Pub. Date: Aug. 21, 2008

(54) Z-MOTION MICROSCOPE SLIDE MOUNT

(75) Inventors: Wei Guo, Unionville, CT (US); Triantafyllos Tafas, Rocky Hill, CT (US)

Correspondence Address: KELLEY DRYE & WARREN LLP, 400 ALTLANTIC STREET , 13TH FLOOR, STAMFORD, CT, 06901, US

(73) Assignee: Ikonisys, Inc., New Haven, CT (US)

(21) Appl. No.: 11/833,183

(22) Filed: Aug. 2, 2007

Related U.S. Application Data
(60) Provisional application No. 60/821,538, filed on Aug. 4, 2006.

(51) Int. Cl. G02B 21/26

(52) U.S. Cl. 359/392

(57) ABSTRACT

A microscope slide mount capable of z-axis movement.

### RELATED APPLICATIONS

This application claims the benefit of priority of U.S. Provisional 821,545 filed Aug. 4, 2006, which is incorporated herein by reference in its entirety.

### BACKGROUND OF THE INVENTION

All references cited in this specification, and their references, are reference herein where appropriate for teachings of additional or alternative and/or technical background.

### FIELD OF THE INVENTION

The present invention generally relates to automated microscopes, and more particularly to a microscope stage that is adjustably moveable along the optic axis of the microscope.

### DESCRIPTION OF THE RELATED ART

Conventional optical microscopy generally employs a microscope slide to which a biological sample has been affixed, and a single objective lens that is used to focus on discrete areas of the biological sample in a search for structures of interest, such as cells, nuclei, etc. Microscopes historically have consisted of an optical portion including the eyepiece, body tube and objective; the flame, made up of a limb, joint and foot; and the ace to which the microscope slide is positioned for viewing.

Because optics will magnify any instability of the subject under examination stability of the slide has been accomplished with spring-clamp-like fingers mounted to the stage. The fingers exhibit a pressure on the slide, holding it firmly to the platter surface. Although this method has marginal success, repositioning the slide in the Z-axis has not been possible as the stage is typically firmly mounted to the frame or cast thereto.

The present invention addresses these deficiencies.

### SUMMARY OF THE INVENTION

Embodiments disclosed herein include:

A microscope slide mount adjustable along a direction of the optic axis of said microscope, comprising a base plate, a microscope stage assembly movably mounted on said base plate operably configured to permit displacement of said assembly along the direction of the optic axis; and a microscope slide holding means fixed to said microscope stage assembly.

A variable elevation microscope slide stage comprising: a base plate having at least one guide pin perpendicularly mounted thereon and a base rail along one edge; a piezo electric motor having a mounting surface and a driving surface attached to the base plate at the mounting surface, an inclined first platform having at least one slot operatively configured to engage the guide pin(s) and to allow movement along the slot in the direction of the slot in the inclined platform, the inclined first platform positioned between the piezo electric motor driving surface and the base rail and slideable on the base plate when the piezo electric motor driving surface is activated; a correspondingly inclined second platform in opposing inclined contact to the inclined first platform, the inclined second platform having a second platform top surface and second platform bottom surface, the second platform bottom surface having cavities configured to accept the base guide pin to allow for vertical displacement about the base guide pin when the inclined first platform slides on the base plate.

A spring tension microscope slide holder comprising: a base plate having a top surface and a bottom surface, the base plate having two parallel lateral sides, and a front side and back side, and having at least one pin perpendicularly mounted to the top surface of the base plate; a first and second rail positioned along the parallel lateral sides of the top surface of the base plate and defining a channel therebetween, the first rail being fixedly attached to the base plate and the second rail having at least one cavity therein corresponding to the position of the pin on the base plate and configured with respect to the pin to permit horizontal displacement about the pin; a lever pivotally connected to the base plate and operatively configured to impinge upon a surface of the second rail and to provide a horizontal displacement force to the second rail when pivoted in a first direction but not in a second direction.

### DETAILED DESCRIPTION OF THE INVENTION

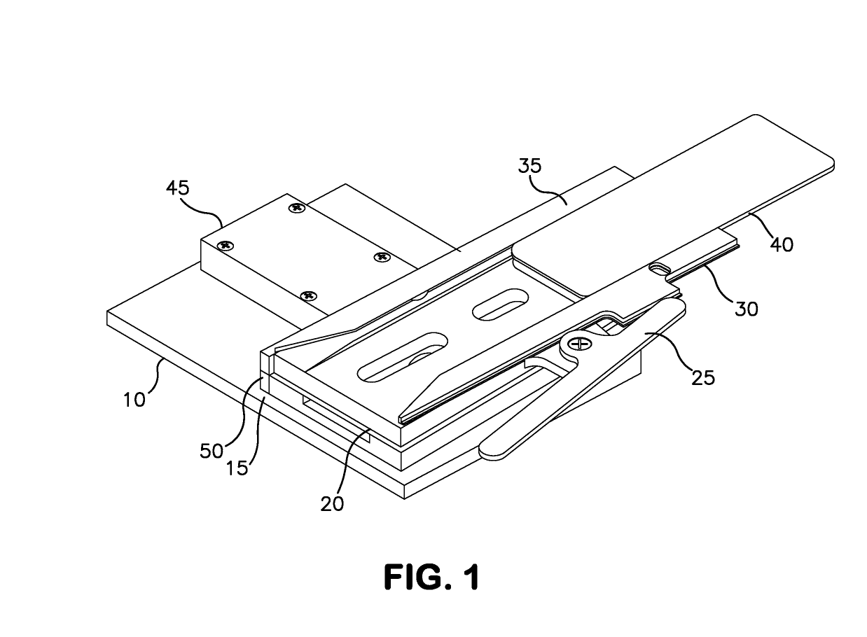

Turning FIG. 1, there is disclosed a parametric illustration of an embodiment representing z-axis adjustable slide holder in a neutral position.

As indicated in FIG. 1, a microscope slide 40 is loaded onto the upper surface of plate 20 having a fixed edge guide 35 opposed by an adjustable, locking edge guide 30 such that the slide is clamped between the two guides and latched into place by the locking lever 25. Plate 20, the top portion of two vertically opposing wedges, is opposed by the lower wedge portion 15 so as when the lower portion of the opposing wedge moves laterally on base 10, the height of the microscope slide changes relative to the base.

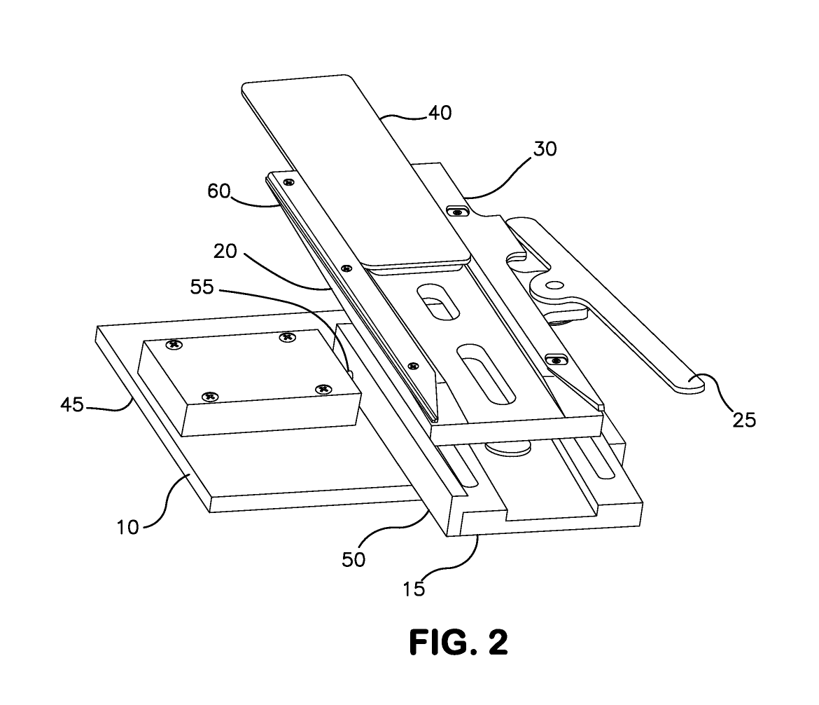

As depicted in FIG. 2, motion of the lower portion 15 of the opposing wedges is transacted, for example, by a piezo motor 45, rigidly mounted to the base 10 in a manner providing contact of tip 55 to a friction surface plate 50, rigidly mounted to the lower portion 15 of the opposing wedges. Mounting of a friction surface plate 50 is such so as to allow freedom of lateral movement between the two wedge portions 15 and 20.

Lateral motion of the lower portion 15 of the opposing wedges relative to the upper portion 20 of the opposing wedges and in a direction of increasing opposition, translates into a positive z-axis movement relative to the neutral position as seen by comparison of FIG. 1 with FIG. 2.

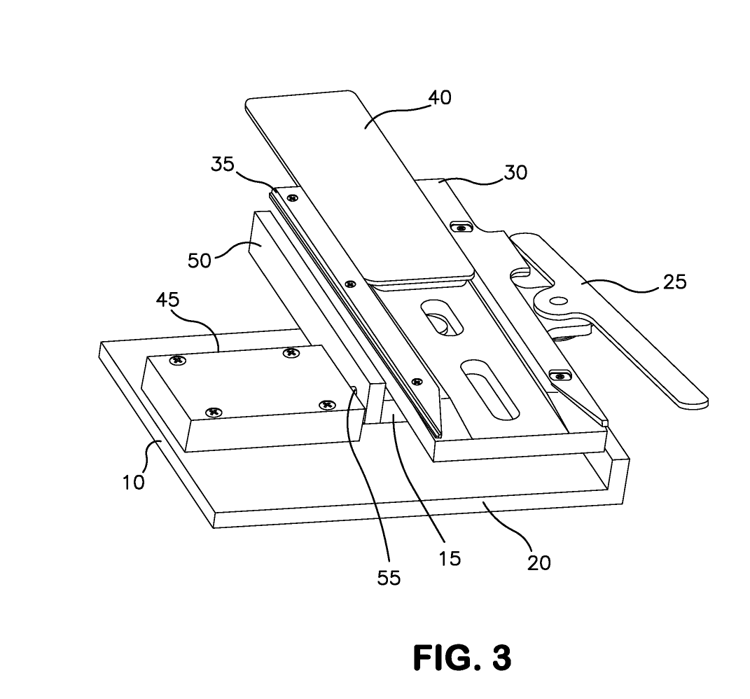

Opposite motion of the two opposing wedges 15 and 20, in a direction of decreasing opposition, as depicted in FIG. 3, translates into a negative z-axis movement relative to the neutral position as seen in FIG. 1.

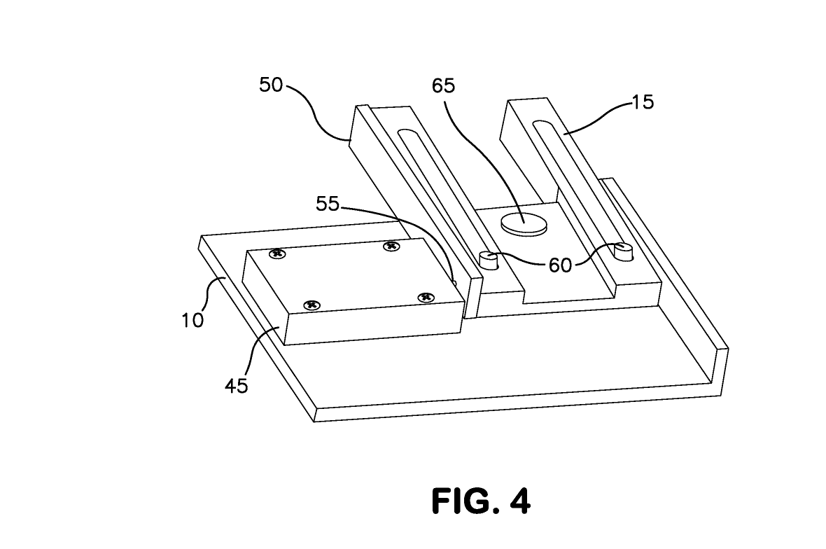

Turning to FIG. 4, in a view depicting the lower portion 15 of the opposing wedges in a lower microscope slide z-axis position, the upper portion of the opposing wedges along with their edge guides, the slide and the locking lever are removed to depict one possible relationship of the opposing wedges to one another, and a possible relationship of the opposing wedges to that of the base.

Movement of the lower portion 15 of the opposing wedges, resulting in a change in the z-axis of the slide 40 (not shown) relative to the base 10, is accomplished, for example, by maintaining stationary the upper portion 20 (also not shown) of the two opposing wedges by use of two pins 60 operatively connected at one end to the base and operatively connected at the opposing end to the upper portion of the two opposing wedges. Magnet 65, held in the lower portion 15 of the opposing wedges, provides resilient attractive forces to maintain proximity of the wedge portions to each other and the lower portion to the base 10. Upper portion 20 of the two opposing wedges may include a section therein (not shown) of Mu metal to reduce or eliminate possible effects from said magnet 65 on the sample held on slide 10.

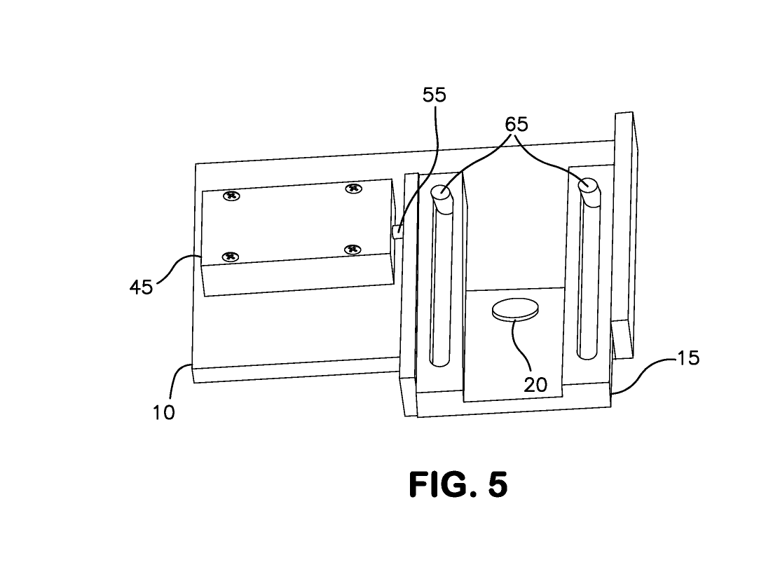

FIG. 5 illustrates another view of the base 10, motor 45, tip 55, friction surface plate 50, lower portion 15 of the opposing wedges, and pins 60; such that the lower portion 15 is in a higher microscope slide z-axis position.

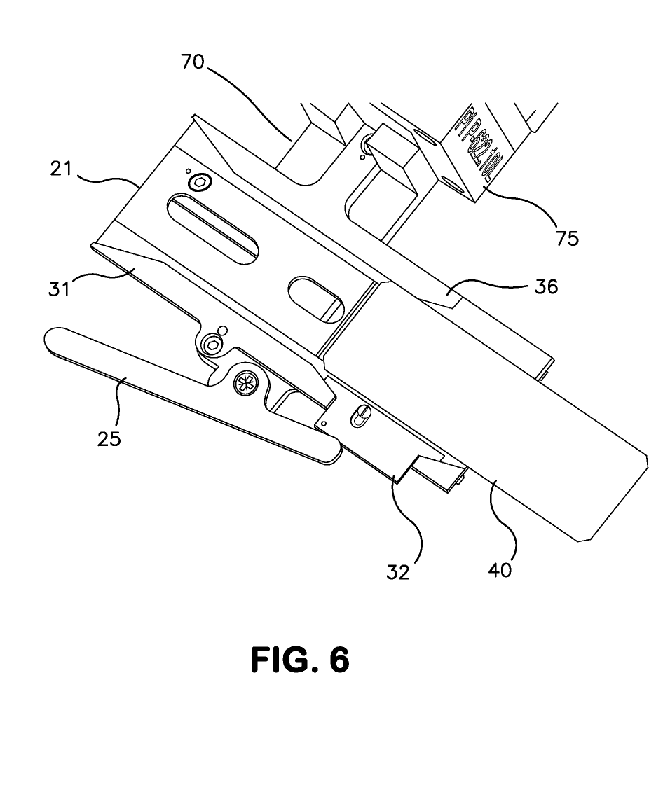

An alternative embodiment of a microscope slide holder is illustrated in the top down perspective of FIG. 6. Slide 40 is shown partially loaded on the surface of slide holder plate 21 having integral edge guides 31 and 36. Locking the slide into place is accomplished by movable edge guide portion 32, currently retracted, and actuated by lever 25. Plate 21 is attached to mount 70 from which actuator 75 translates vertical motion to the microscope slide 40. In this embodiment the mount 70 is fixed to the actuating means 75 so that the slide holder 21 is directly displaced along the direction of the optic axis.

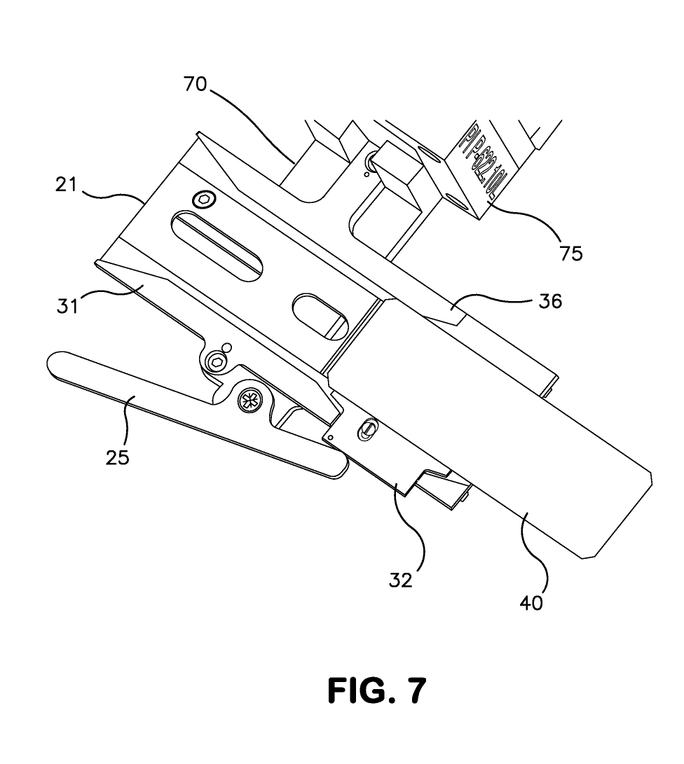

FIG. 7 is an alternative view of the microscope slide holder in FIG. 6, hereto having the movable edge guide portion 32 advanced against the microscope slide edge by lever 25 and opposed on the opposite slide edge by the integral edge guide 36.

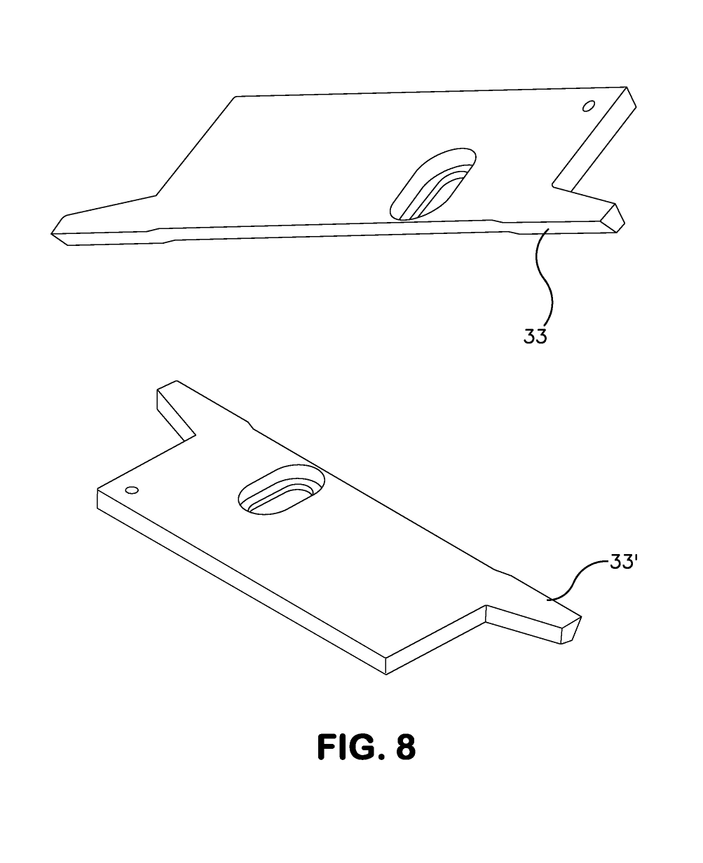

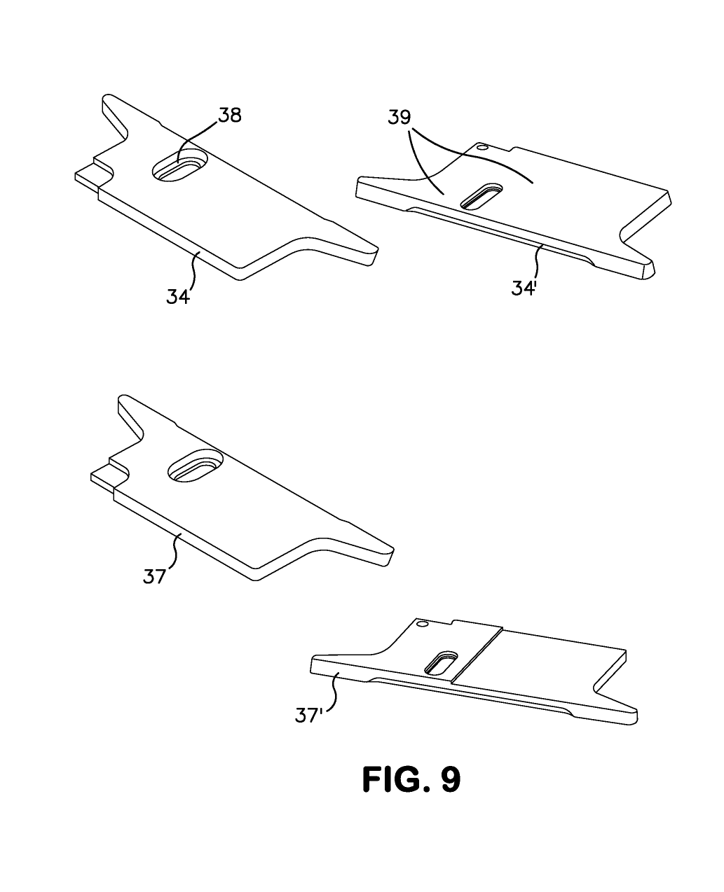

Alternative embodiments of a movable edge guide 33 and 33′ are depicted in FIG. 8; movable edge guide 33′ being a rotated image of guide 33. Additional variations, illustrated in FIG. 9 demonstrate, for example, treated surfaces 38 and 39 on movable edge guides 34 and 34′ respectively. Moveable edge guide 37, for example, has no surface treatments, however, an alternative view 37′ of the moveable edge guide shows variations in the surface contour of the bottom side.

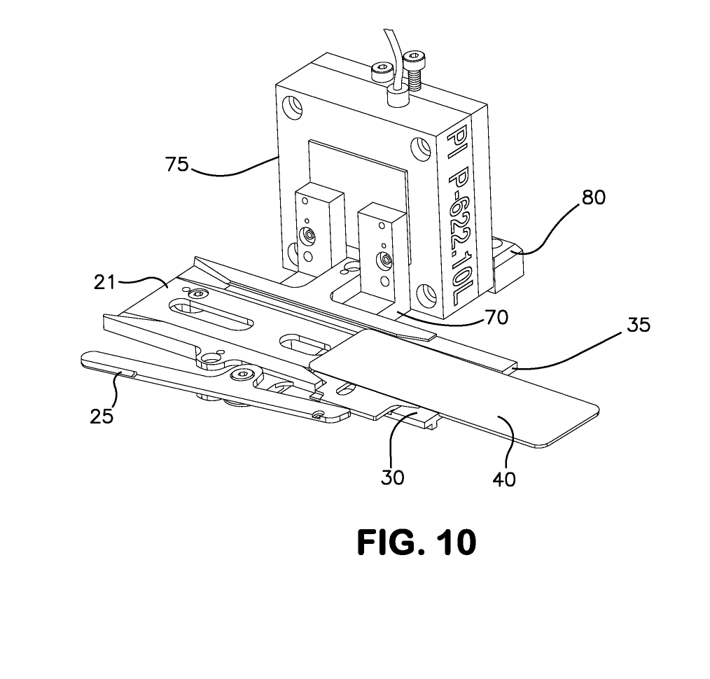

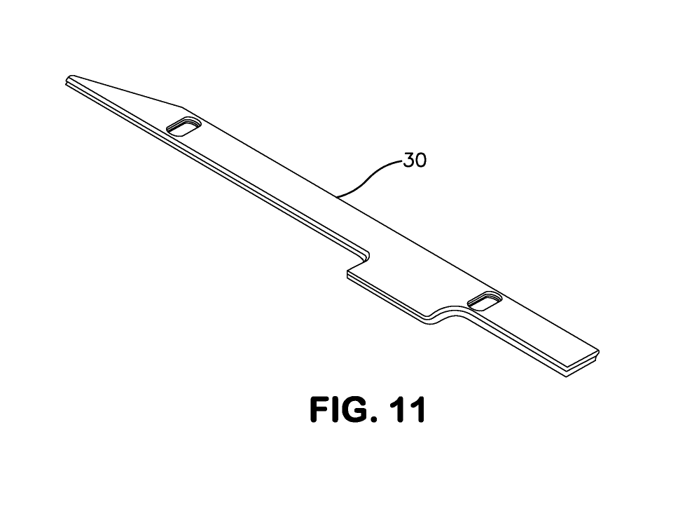

Further to the embodiment shown in FIG. 6, FIG. 10 depicts a possible arrangement for the attachment of the slide holder vertical axis actuator 75 to a mounting bracket 80. In this embodiment, slide holder 21 makes use of replaceable edge guide 35 and replaceable and movable edge guide 30, also depicted in FIG. 11.

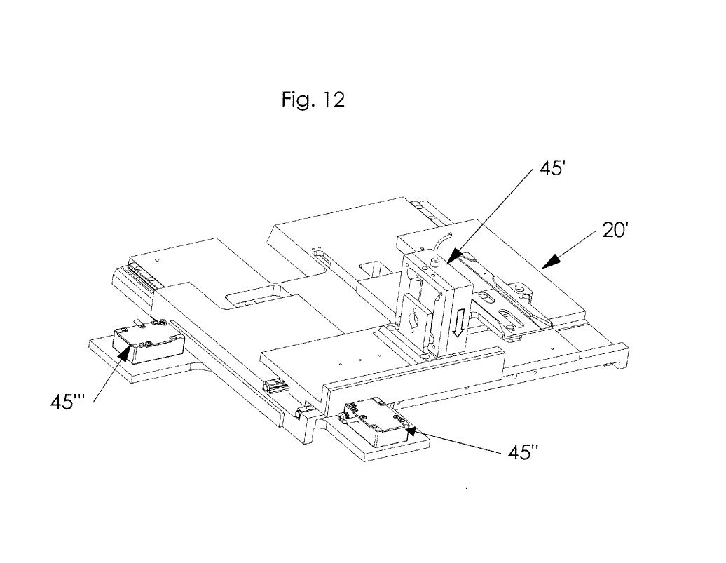

Further to the embodiment shown in FIG. 12, there is illustrated a slide stage assembly capable of movement along the z-axis without need for employing opposing wedges to transact the z-motion as in FIGS. 1-4. In the embodiment of FIG. 10, piezo motor 45′, rigidly mounted to the base 10, is used to transact z motion. Piezo motors 45″ and 45′″ are used to transact x/y motion of plate 20′. Thus each of x, y and z motion is under control of a piezo motor. A control signal may be sent to each motor, or just to the motors to be effectuated into action. Such signal may be automatically generated pursuant to a control module which may include hardware and/or software components operatively configured to generate a predetermined movement of the slide over a period of time. Such control signal may also encompass manual input.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims.

We claim:

1. A microscope slide mount adjustable along a direction of the optical axis of said microscope, comprising
(a) a base plate;
(b) a microscope stage assembly movably mounted on said base plate operably configured to permit displacement of said assembly along the direction of the optic axis; and
(c) a microscope slide holding structure fixed to said microscope stage assembly.

2. A microscope slide mount in accord with claim 1 wherein the microstate stage assembly permits displacement along the direction of the optic axis by means of one or more piezo motors.

3. A microscope slide mount in accord with claim 2 wherein there is employed at least three piezo motors, each being positioned as to transact movement of said assembly along a different axis.

4. The microscope slide mount described in claim 1 wherein said microscope stage assembly comprises a first wedged plate opposing a second wedged plate; wherein
(a) said first wedged plate having a lower surface slideable along the base plate in a plane essentially perpendicular to the optic axis, and having at least one upper surface wedged with respect to said first wedged plate lower surface at an angle other than parallel thereto;
(b) said second wedged plate being laterally fixed with respect to said base plate, having an upper surface essentially parallel to said base plate and at least one lower surface wedged with respect to said second wedged plate upper surface at an angle other than parallel thereto, wherein the at least one upper surface of said first wedged plate slideably engages the at least one lower wedged surface of said second wedged plate;
(c) said second wedged plate further having a structure for holding a microscope slide affixed to the upper surface thereof; and wherein
(d) horizontal displacement of said first wedged plate with respect to said second wedged plate causes the upper surface of said second wedged plate to move along the optic axis.

5. The microscope slide mount described in claim 2 wherein a motorized means fixed to said base plate operably engages said first wedged plate thereby displacing said first wedged plate with respect to said second wedged plate.

6. The microscope slide mount described in claim 3 wherein said motorized means comprises a motor selected from the group consisting of a piezo electric motor, a servo motor, a synchronous motor, and a step motor.

7. The microscope slide mount described in claim 1 wherein said microscope stage assembly is fixedly mounted to motorized means that displaces said assembly along the direction of the optic axis.

8. The microscope slide mount described in claim 5 wherein said motorized means comprises a motor selected from the group consisting of a piezo electric motor, a servo motor, a synchronous motor, and a step motor.

9. A variable elevation microscope slide stage comprising:
a base plate having at least one guide pin perpendicularly mounted thereon and a base rail along one edge;
a piezo electric motor having a mounting surface and a driving surface attached to said base plate at said mounting surface;
an inclined first platform having at least one slot operatively configured to engage said guide pin(s) and to allow movement along said slot in the direction of said slot in said inclined platform, said inclined first platform positioned between said piezo electric motor driving surface and said base rail and slideable on said base plate when said piezo electric motor driving surface is activated;
a correspondingly inclined second platform in opposing inclined contact to said inclined first platform, said inclined second platform having a second platform top surface and second platform bottom surface, said second platform bottom surface having cavities configured to accept said base guide pin to allow for vertical displacement about said base guide pin when said inclined first platform slides on said base plate.

10. A spring tension microscope slide bolder comprising:
a base plate having a top surface and a bottom surface, said base plate having two parallel lateral sides, and a front side and back side, and having at least one pin perpendicularly mounted to said top surface of said base plate;
a first and second rail positioned along said parallel lateral sides of said top surface of said base plate and defining a channel therebetween, said first rail being fixedly attached to said base plate and said second rail having at least one cavity therein corresponding to the position of said pin on said base plate and configured with respect to said pin to permit horizontal displacement about said pin;
a lever pivotally connected to said base plate and operatively configured to impinge upon a surface of said second rail and to provide a horizontal displacement force to said second rail when pivoted in a first direction but not in a second direction.
